(19) United States
(12) Patent Application Publication
(10) Pub. No.: US 2013/0290196 A1
(43) Pub. Date: Oct. 31, 2013

(54) Automated Term Protection

(71) Applicant: Christopher Hegos Gillespie, Denton, TX (US)

(72) Inventor: Christopher Hegos Gillespie, Denton, TX (US)

(21) Appl. No.: 13/857,891

(22) Filed: Apr. 5, 2013

Related U.S. Application Data
(60) Provisional application No. 61/620,441, filed on Apr. 5, 2012.

(51) Int. Cl. G06Q 50/18; G06F 17/30

(52) U.S. Cl. CPC G06Q 50/184; G06F 17/30985
USPC 705/310

(57) ABSTRACT

An automated means to protect proprietary terms (e.g., a company name, a product name or slogan, etc.) from use by third parties, where such use may dilute the power of the term (e.g., allowing a product name to be used like a generic term, allowing a company name to be used as a verb, etc.) is disclosed.

### CROSS-REFERENCE TO RELATED APPLICATION

The present application claims the benefit under 35 U.S.C. §119(e) of U.S. Provisional Application No. 61/620,441, filed Apr. 5, 2012, which is incorporated herein by reference.

### FIELD OF THE INVENTION

The present invention relates generally to the field of communications. More specifically, the invention relates to systems and methods for protecting one or more terms (e.g., a company name, a product name or slogan, etc.) from use by third parties, where such use may dilute the power of the term rendering the term or terms generic.

### BACKGROUND OF THE INVENTION

Businesses need an automated means to protect proprietary terms (e.g., a company name, a product name or slogan, etc.) from use by third parties, where such use may dilute the power of the term (e.g., allowing a product name to be used like a generic term, allowing a company name to be used as a verb, etc.).

### BRIEF DESCRIPTION OF THE DRAWINGS

The novel features of the invention are set forth in the appended claims. However, for purpose of explanation, several embodiments of the invention are set forth in the following drawings.

FIG. 1 illustrates a schematic block diagram of a conceptual system according to some embodiments of the invention;

FIG. 2 illustrates a flow chart of a conceptual process used by some embodiments to register multiple domain names; and

FIG. 3 illustrates a schematic block diagram of a conceptual computer system with which some embodiments of the invention may be implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a way to protect one or more terms (e.g., a company name, a product name or slogan, etc.) from use by third parties, where such use may dilute the power of the term (e.g., allowing a product name to be used like a generic term, allowing a company name to be used as a verb, etc.). Some embodiments include the protected term in multiple concatenated strings, where each string includes the protected term, a set of dictionary terms (and/or a set of search terms), and a domain extension.

For example, company may wish to register multiple domains that may be associated with the company name. A set of dictionary terms may include various popular search terms. In some embodiments the company name will be concatenated with each of the terms in the dictionary and all variations may be registered within the selected domain extension(s). In some embodiments, additional terms may be added based on search trends, availability of more recent data, etc. The additional terms may be concatenated with the company name and all variations may again be registered within the selected domain extension(s).

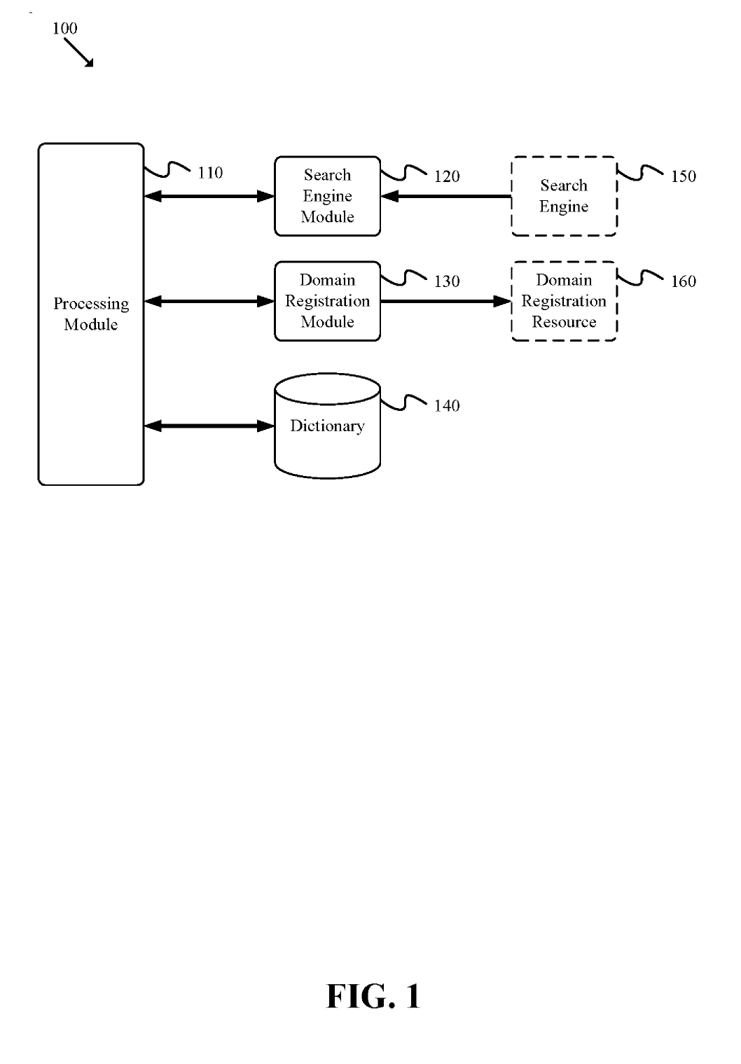

FIG. 1 illustrates a schematic block diagram of a conceptual system 100 according to some embodiments of the invention. As shown, the system 100 includes a processing module 110, a search engine module 120, a domain registration module 130, and a dictionary 140. In addition, the system may have access to a search engine 150 (and/or data provided by the search engine) and/or a domain registration resource 160.

The processing module 110 may be adapted to send and receive data among various components, process instructions and/or data, and/or control or direct various other system modules. The processing module 110 may also be adapted to send information to and/or receive information from various entities (e.g., individual users, electronic devices, external software components, communications interfaces, etc.). For instance, the processing module 110 may be able to receive a company name from a user entered at any appropriate terminal (e.g., personal computer, Smartphone, tablet device, etc.) in order to implement the appropriate domain registrations based on the name (and/or domain extensions, dictionary criteria, and/or other appropriate elements).

The search engine module 120 may be adapted to retrieve search engine information and provide the information to the processing module 110. In addition, the search engine module 120 may be adapted to retrieve information from other appropriate internal and/or external data sources (e.g., marketing reports, survey data, etc.) in various appropriate formats.

The domain registration module 130 may be adapted to generate information and/or commands related to a set of domains to be registered. In addition, the domain registration module 130 may be adapted to interact with the domain registration resource 160, as appropriate.

The dictionary 140 may be adapted to store various terms, elements, etc. that may be used by the processing module 110. The dictionary 140 may be periodically updated, as appropriate. In addition, some embodiments may include multiple dictionaries (e.g., the dictionaries may be optimized for various market segments, product types, etc.) that may be used alternatively or conjunctively. Furthermore, some embodiments may include dictionaries in multiple languages (e.g., English, Japanese, Cantonese, etc.). Different embodiments may utilize different combinations of dictionaries (e.g., a first embodiment may utilize an English dictionary and a Spanish dictionary while a second embodiment may utilize only a Japanese dictionary, a third embodiment may use a dictionary made up solely of search terms while a fourth embodiments may use a dictionary made up of various marketing keywords provided by a user, etc.). Some embodiments may include customized dictionaries.

The search engine 150 may be adapted to provide information (e.g., statistics regarding search terms, keywords, etc.) regarding searches performed by Internet users. For instance, some embodiments may generate a dictionary by retrieving a set of search terms ranked by popularity (e.g., by number of instances each particular term was entered in any searches).

The domain registration resource 160 may be adapted to register a set of domain names. Such registration may be performed automatically based on data provided by the domain registration module 130.

During operation, the processing module 110 may have access to the term to be protected (e.g., the term may be provided by a user). The processing module may then retrieve a set of dictionary terms from the dictionary 140 and/or a set of search engine terms may be retrieved from the search engine module 120. The search engine module may retrieve the terms from one or more search engines 150 and/or other appropriate resources. The processing module 110 may then generate a set of concatenated strings, each string including the term to be protected and a different dictionary and/or search engine term. In addition, a domain extension may be added to the concatenated string, where the domain extension(s) may also have been provided or selected by a user. The resulting set of concatenated strings may then be passed to the domain registration module 130 in an appropriate format. The domain registration module may then direct the domain registration resource 160 to register the set of concatenated strings.

One of ordinary skill in the art will recognize that system 100 is conceptual and may be implemented in various different ways without departing from the spirit of the invention. For instance, the system may include additional elements (e.g., modules, storages, communication pathways, etc.). As another example, various elements may be combined into a single element (e.g., the search engine module may be combined with the processing module in some embodiments). As yet another example, various individual elements may be broken into sub-components (e.g., the processing module may be divided into a communication module and a computing module in some embodiments).

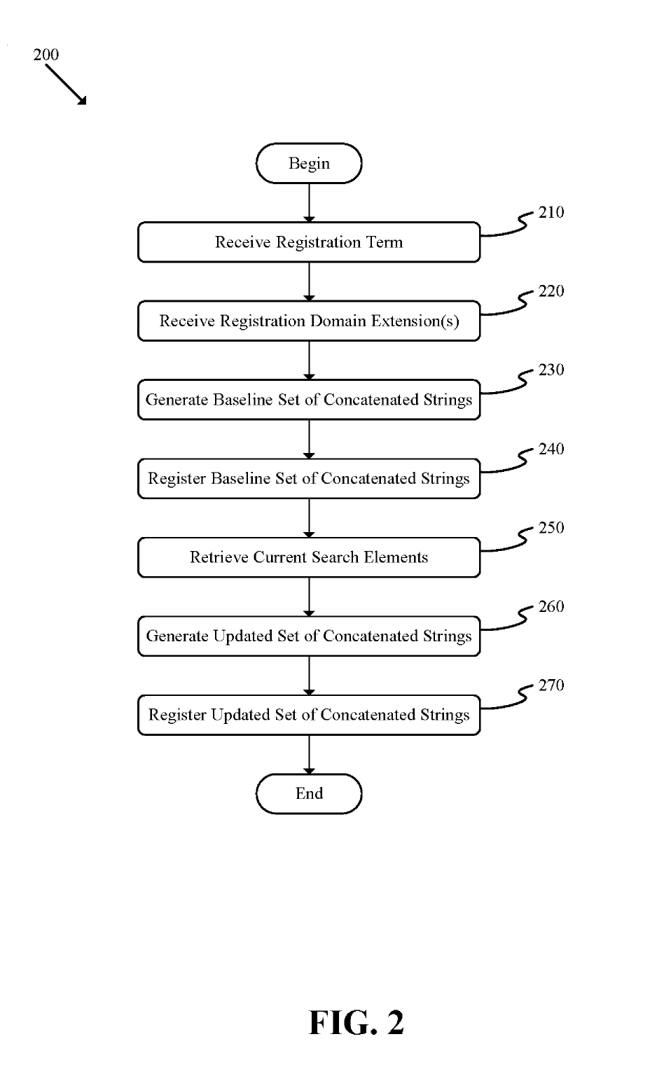

FIG. 2 illustrates a flow chart of a conceptual process 200 used by some embodiments to register multiple domain names. The process may be implemented using a system such as system 100 described above in reference to FIG. 1. Process 200 may begin, for example, when a user launches an application provided by some embodiments, when a user submits a term to be protected, etc. As shown, the process then may receive (at 210) a registration term. Such a term may include various combinations of letters, numbers, and/or characters. Next, the process may receive (at 220) one or more registration domain extensions. Such extensions may be received in various appropriate ways (e.g., a list of domain extensions may be provided by a user, a list of extensions may be provided to a user and the user may select a set of extensions, etc.).

Process 200 may then generate (at 230) a baseline set of concatenated strings. Such strings may include elements such as the term to be protected, various dictionary terms, etc. as described above. Next, the process may register (at 240) the baseline set of concatenated strings.

The process may then retrieve (at 250) a set of current search elements. The current search elements may then be used to generate (at 260) an updated set of concatenated strings. The process may then register (at 270) the updated set of concatenated strings and end. In some embodiments, operations 250-270 may be repeated at regular intervals (e.g., daily, weekly, monthly, etc.) in order to make sure that the most up-to-date search terms are being used.

One of ordinary skill in the art will recognize that process 200 is conceptual and may be performed in various different ways without departing from the spirit of the invention. For instance, some embodiments may divide the process into multiple sub-processes. As another example, some embodiments may include the process as a sub-process of a larger macro process. In addition, the operations of the process may be performed in various different orders, additional operations may be performed, and/or various operations may be omitted. Furthermore, the process may be performed concurrently with, subsequent to, or prior to one or more other processes.

Many of the processes and modules described above may be implemented as software processes that are specified as at least one set of instructions recorded on a non-transitory storage medium. When these instructions are executed by one or more computational element(s) (e.g., microprocessors, microcontrollers, Digital Signal Processors (“DSP”), Application-Specific ICs (“ASIC”), Field Programmable Gate Arrays (“FPGA”), etc.) the instructions cause the computational element(s) to perform actions specified in the instructions.

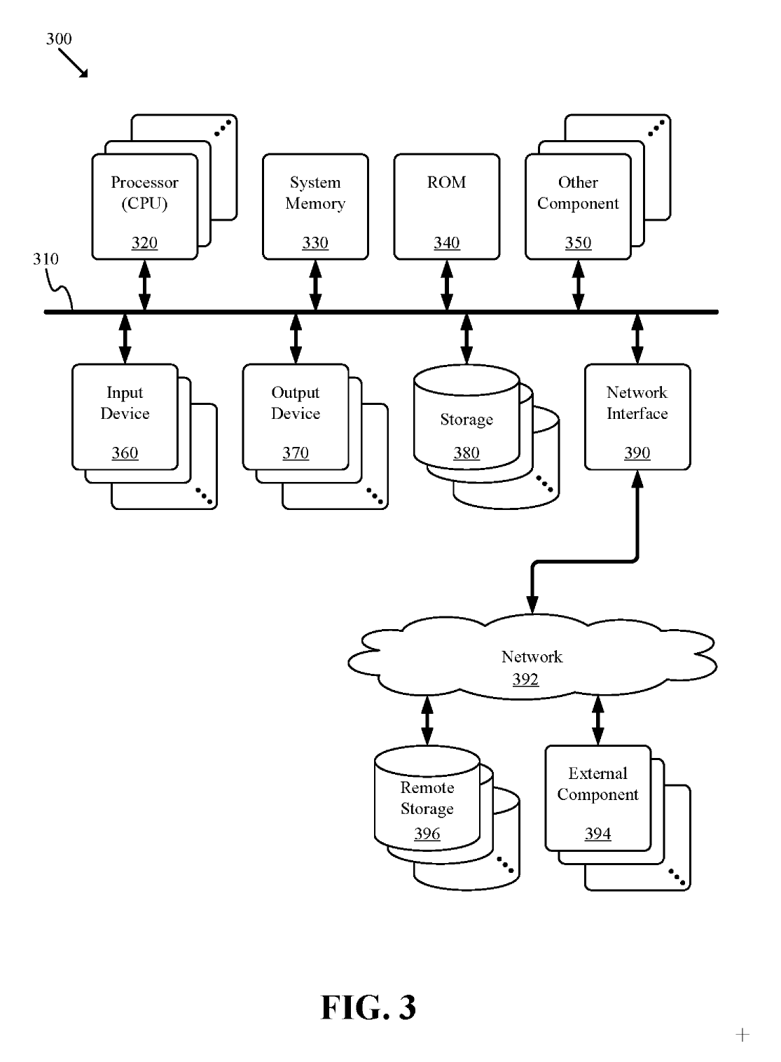

FIG. 3 conceptually illustrates a schematic block diagram of a computer system 300 with which some embodiments of the invention may be implemented. For example, the system described above in reference to FIG. 1 may be at least partially implemented using computer system 300. As another example, the process described in reference to FIG. 2 may be at least partially implemented using sets of instructions that are executed using computer system 300.

Computer system 300 may be implemented using various appropriate devices. For instance, the computer system may be implemented using one or more personal computers (“PC”), servers, mobile devices (e.g., a Smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

Computer system 300 may include a bus 310, at least one processing element 320, a system memory 330, a read-only memory (“ROM”) 340, other components (e.g., a graphics processing unit) 350, input devices 360, output devices 370, permanent storage devices 380, and/or a network connection 390. The components of computer system 300 may be electronic devices that automatically perform operations based on digital and/or analog input signals.

Bus 310 represents all communication pathways among the elements of computer system 300. Such pathways may include wired, wireless, optical, and/or other appropriate communication pathways. For example, input devices 360 and/or output devices 370 may be coupled to the system 300 using a wireless connection protocol or system. The processor 320 may, in order to execute the processes of some embodiments, retrieve instructions to execute and data to process from components such as system memory 330, ROM 340, and permanent storage device 380. Such instructions and data may be passed over bus 310.

ROM 340 may store static data and instructions that may be used by processor 320 and/or other elements of the computer system. Permanent storage device 380 may be a read-and-write memory device. This device may be a non-volatile memory unit that stores instructions and data even when computer system 300 is off or unpowered. Permanent storage device 380 may include a mass-storage device (such as a magnetic or optical disk and its corresponding disk drive).

Computer system 300 may use a removable storage device and/or a remote storage device as the permanent storage device. System memory 330 may be a volatile read-and-write memory, such as a random access memory (“RAM”). The system memory may store some of the instructions and data that the processor uses at runtime. The sets of instructions and/or data used to implement some embodiments may be stored in the system memory 330, the permanent storage device 380, and/or the read-only memory 340.

Other components 350 may perform various other functions, as appropriate (e.g., interfacing with various search engines, domain registration services, etc.).

Input devices 370 may enable a user to communicate information to the computer system and/or manipulate various operations of the system. The input devices may include keyboards, cursor control devices, audio input devices and/or video input devices. Output devices 380 may include printers, displays, and/or audio devices. Some or all of the input and/or output devices may be wirelessly or optically connected to the computer system.

Finally, as shown in FIG. 3, computer system 300 may be coupled to a network 392 through a network adapter 390. For example, computer system 300 may be coupled to a web server on the Internet such that a web browser executing on computer system 300 may interact with the web server as a user interacts with an interface that operates in the web browser.

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 300 may be used in conjunction with the invention. Moreover, one of ordinary skill in the art will appreciate that many other system configurations may also be used in conjunction with the invention or components of the invention.

Moreover, while the examples shown may illustrate many individual modules as separate elements, one of ordinary skill in the art would recognize that these modules may be combined into a single functional block or element. One of ordinary skill in the art would also recognize that a single module may be divided into multiple modules.

While the invention has been described with reference to numerous specific details, one of ordinary skill in the art will recognize that the invention can be embodied in other specific forms without departing from the spirit of the invention. For example, several embodiments were described above by reference to particular features and/or components. However, one of ordinary skill in the art will realize that other embodiments might be implemented with other types of features and components. One of ordinary skill in the art would understand that the invention is not to be limited by the foregoing illustrative details, but rather is to be defined by the appended claims.

I claim:

1. A system adapted to protect a name from generic usage, the system comprising:
a dictionary adapted to store a set of relevant terms;
a processing module adapted to retrieve the set of relevant terms and generate a set of concatenated strings, each string including the name, a relevant term from the set of relevant terms, a domain extension; and
a domain registration module adapted to receive the set of concatenated strings and initiate registration of each concatenated string in the set of concatenated strings.

2. The system of claim 1, where the set of relevant terms includes a plurality of terms retrieved from at least one search engine.
